(19) United States
(12) Patent Application Publication
(10) Pub. No.: US 2020/0254287 A1
(43) Pub. Date: Aug. 13, 2020

(54) ESCAPE SYSTEM

(71) Applicants: Weijin REN, Qionglai City, Chengdu, Sichuan (CN); Zhengyu REN, Qionglai City, Chengdu, Sichuan (CN)

(72) Inventors: Weijin REN, Qionglai City, Chengdu, Sichuan (CN); Zhengyu REN, Qionglai City, Chengdu, Sichuan (CN)

(21) Appl. No.: 16/755,214

(22) PCT Filed: Jun. 1, 2018
(86) PCT No.: PCT/CN2018/089662

§ 371 Date: Apr. 10, 2020

(30) Foreign Application Priority Data
Oct. 11, 2017 (CN) 201710940099.7

(51) Int. Cl. A62B 1/20

(52) U.S. Cl. CPC A62B 1/20

(57) ABSTRACT

An escape system, including escape panels, locking components, and support assemblies disposed around a building exterior wall on several or all of the building floors. The escape panels surround the building exterior wall to form a closed passage. First ends of the escape panels are rotatably attached to the building exterior wall, and second ends are detachably attached to the building exterior wall by means of the locking components. One end of each support assembly is attached to an escape panel and the other end is movably attached to the building exterior wall, for example in a rotatable or slidable attachment.

### TECHNICAL FIELD

The present disclosure relates to an escape system, and in particular to an escape system.

### BACKGROUND ART

In existing high-rise buildings, a chimney effect may be extremely easily created in the event of a fire. About 75% of deaths in a fire accident are caused by inhalation of toxic gases. However, too few corresponding fire protection facilities are provided in terms of residents' self-rescue and escape, which may easily cause reoccurrence of the fire accident in London. The best self-escape time left for the residents lasts only a few minutes. If a rescue is launched after fire trucks arrive, the rescue time gets longer, and the best rescue time might be missed. Even if the fire trucks come, aerial ladders not high enough will also become a problem. Or once windows with other life-saving equipment are blocked by the fire, the residents cannot escape therefrom, and inestimable consequences may be caused.

### SUMMARY

One of the objects of the present disclosure is to provide an escape system by which the above problems can be solved to a certain extent.

Embodiments of the present disclosure are implemented as follows:

The present disclosure provides an escape system, comprising escape panels disposed around an exterior wall of a building and disposed on some or all of the floors, locking parts, and support components, wherein the escape panels are arranged to surround the exterior wall of the building to form closed passages, the escape panels have first ends rotatably connected to the exterior wall of the building, and second ends detachably connected to the exterior wall of the building by means of the locking parts, the support components each have one end connected to the escape panel, and the other end rotatably connected to the exterior wall of the building, the escape panel has an operative state and an inoperative state, the support component has a first support state and a second support state, the escape panel drives the support component to be flush with the exterior wall of the building when the escape panel is in the inoperative state, and the second end is separated from the exterior wall of the building so that the entire escape panel is perpendicular to the exterior wall of the building and drives the support component to change from the first support state to the second support state when the escape panel is in the operative state.

The present disclosure further provides an escape system, comprising escape panels disposed around an exterior wall of a building and disposed on some or all of the floors, locking parts, and support components, wherein the escape panels are arranged to surround the exterior wall of the building to form closed passages, first ends of the escape panels are movably connected to the exterior wall of the building, second ends of the escape panels are detachably connected to the exterior wall of the building by means of the locking parts, the two ends of each of the support components are connected to the escape panel and to the exterior wall of the building, respectively, the escape panel has an operative state and an inoperative state, the support component has a first support state and a second support state, the escape panel drives the support component to be flush with the exterior wall of the building when the escape panel is in the inoperative state, and the second end is separated from the exterior wall of the building so that the entire escape panel is perpendicular to the exterior wall of the building and drives the support component to change from the first support state to the second support state when the escape panel is in the operative state.

The present disclosure further provides an escape system, comprising escape panels disposed around an exterior wall of a building and disposed on some or all of the floors, locking parts, and support components, wherein grooves are provided on the exterior wall of the building, first ends of the escape panels are disposed in the grooves and are slidably connected to the grooves, and second ends of the escape panels are connected to the exterior wall of the building by means of the support components; the locking parts are disposed on the building and connected to the escape panels, the locking part has an operative state and an inoperative state, the escape panel has a contracted state and a stretched state, the support component has a first support state and a second support state, and when the locking part is in the operative state, the escape panel is in the contracted state, the escape panel drives the support component into the first support state, and the second end of the escape panel is flush with the exterior wall of the building; when the locking component is in the inoperative state, the escape panel is ejected horizontally from the groove relative to the exterior wall of the building to be in the stretched state, the escape panel drives the support component into the second support state, and the second end of the escape panel is far away from the exterior wall of the building, so that the entire escape panel is in a horizontal state relative to the ground, and all the escape panels in the stretched state surround the exterior wall of the building to form a closed passage.

The embodiments of the present disclosure include the following advantageous effects: the embodiments of the present disclosure provide an escape system. The escape system comprises escape panels disposed around an exterior wall of a building and disposed on some or all of the floors, locking parts, and support components. The escape panels are arranged to surround the exterior wall of the building to form closed passages, the escape panels have first ends movably connected to the exterior wall of the building, and second ends detachably connected to the exterior wall of the building by means of the locking parts, and the support components each have one end connected to the escape panel, and the other end rotatably connected to the exterior wall of the building. In the event of a fire, escaping persons can disengage the locking part at each window so that the escape panels on that floor form an escape passage surrounding the exterior wall of the building. Then the escaping persons can move on the escape panels to temporarily go to a unit where no fire has occurred, to take shelter and await rescue by firefighters. If there is no fire in the vicinity of a fire escape in another unit of the building, the escaping persons may also go to the fire escape in another unit over the escape panels and quickly escape through the fire escape. In the event of a major fire or failure to escape through the fire escape in another unit, the escaping persons may descend to the ground at a constant speed by means of the connection of escape connecting rods disposed transversely below window sills of the exterior wall to escape connecting rods disposed longitudinally and attached to the wall. Unobstructed horizontal annular escape passages and rescue passages are formed by opening the escape panels on that floor and the upper floor, and spreading of the fire to the upper floors through heat preservation layers or windows can be suppressed as much as possible.

Additional features and advantages of he present disclosure will be set forth in the following description, which in part will be apparent from the description, or may be learned by practice of the embodiments of the present disclosure. The objectives and other advantages of the present disclosure will be realized and attained by the structure particularly pointed out in the written description, claims, and the appended drawings.

### BRIEF DESCRIPTION OF DRAWINGS

In order to more clearly illustrate technical solutions of embodiments of the present disclosure, drawings required for use in the embodiments will be described briefly below. It is to be understood that the drawings below are merely illustrative of some embodiments of the present disclosure, and therefore should not be considered as limiting its scope. It will be understood by those of ordinary skill in the art that other relevant drawings can also be obtained from these drawings without any inventive effort.

FIG. 1 is a schematic structural view of an escape system according to a first embodiment of the present disclosure;

FIG. 2 is a schematic view showing one state of an escape panel of an escape system according to the first embodiment of the present disclosure;

FIG. 3 is a schematic view showing another state of an escape panel of an escape system according to the first embodiment of the present disclosure;

FIG. 4 is a schematic structural view of a closed passage of an escape system according to the first embodiment of the present disclosure;

FIG. 5 is a schematic view showing connections between escape panels of an escape system according to the first embodiment of the present disclosure;

FIG. 6 is a schematic view showing a change in one state of an escape panel of an escape system according to the first embodiment of the present disclosure;

FIG. 7 is a schematic view showing a change in another state of an escape panel of an escape system according to the first embodiment of the present disclosure;

FIG. 8 is a schematic structural view of a support component of an escape system according to the first embodiment of the present disclosure;

FIG. 9 is a schematic view showing connections of locking parts on adjacent floors of an escape system according to a first embodiment of the present disclosure;

FIG. 10 is a schematic structural view of an escape system according to a second embodiment of the present disclosure;

FIG. 11 is a partially enlarged schematic view of portion a of FIG. 10 according to the second embodiment of the present disclosure;

FIG. 12 is a schematic view showing one state of an escape panel of an escape system according to a third embodiment of the present disclosure, in which a support component is designed in a top pulling mode;

FIG. 13 is a schematic view showing another state of an escape panel of an escape system according to the third embodiment of the present disclosure, in which the support component is designed in a top pulling mode;

FIG. 14 is a schematic view showing one state of an escape panel of an escape system according to the third embodiment of the present disclosure, in which a support component is designed in a bottom supporting mode; and

FIG. 15 is a schematic view showing another state of an escape panel of an escape system according to the third embodiment of the present disclosure, in which a support component is designed in a bottom supporting mode.

Reference Numerals: 100-escape system; 110-escape panel; 111-first end; 112-second end; 113-load bearing layer; 114-fireproof and heat-insulating layer; 120-locking part; 130-support component; 140-closed passage 160-transverse pipeline; 161-transverse sliding slot; 170-longitudinal pipeline; 171-longitudinal sliding slot; 200-exterior wall of building; 210-groove.

### DETAILED DESCRIPTION OF EMBODIMENTS

In order to further clarify the objects, technical solutions, and advantages of the embodiments of the present disclosure, the technical solutions of the embodiments of the present disclosure will be described below clearly and completely with reference to the drawings of the embodiments of the present disclosure. It is apparent that the embodiments to be described are some, but not all of the embodiments of the present disclosure. Generally, the components of the embodiments of the present disclosure, as described and illustrated in the drawings herein, may be arranged and designed in a wide variety of different configurations.

Thus, the following detailed description of the embodiments of the present disclosure, as represented in the drawings, is not intended to limit the scope of the present disclosure as claimed, but is merely representative of selected embodiments of the present disclosure. All the other embodiments obtained by those of ordinary skill in the art in light of the embodiments of the present disclosure without inventive efforts will fall within the scope of the present disclosure as claimed.

It should be noted that similar reference numerals and letters refer to similar items in the following drawings, and thus once a certain item is defined in one figure, it may not be further defined or explained in the following figures.

In the description of the present disclosure, it should be noted that orientation or positional relationships indicated by the terms such as “up”, “down”, “left”, “right”, and “vertical” are the orientation or positional relationships shown based on the drawings, or the orientation or positional relationships in which the inventive product is conventionally placed in use, and these terms are intended only to facilitate the description of the present disclosure and simplify the description, but not intended to indicate or imply that the referred devices or elements must be in a particular orientation, or constructed or operated in the particular orientation, and therefore should not be construed as limiting the present disclosure. In addition, terms such as “first” and “second” are used for distinguishing the description only, and should not be understood as an indication or implication of relative importance.

In addition, the term “horizontal”, “vertical”, “overhanging”, or the like does not mean that a component is required to be absolutely horizontal or overhanging, but means that the component may be slightly inclined. For example, by the term “horizontal”, it is simply meant that its direction is more horizontal than the term “vertical”, and it is not meant that the structure must be completely horizontal, but it is meant that the structure may be slightly inclined.

In the description of the present disclosure, it should also be noted that the terms “provide”, “mount”, “couple”, and “connect” should be understood broadly unless otherwise expressly specified or defined. For example, connection may be fixed connection or detachable connection or integral connection, may be mechanical connection or electric connection, or may be direct coupling or indirect coupling via an intermediate medium or internal communication between two elements. The specific meanings of the above-mentioned terms in the present disclosure can be understood by those of ordinary skill in the art according to specific situations.

### First Embodiment

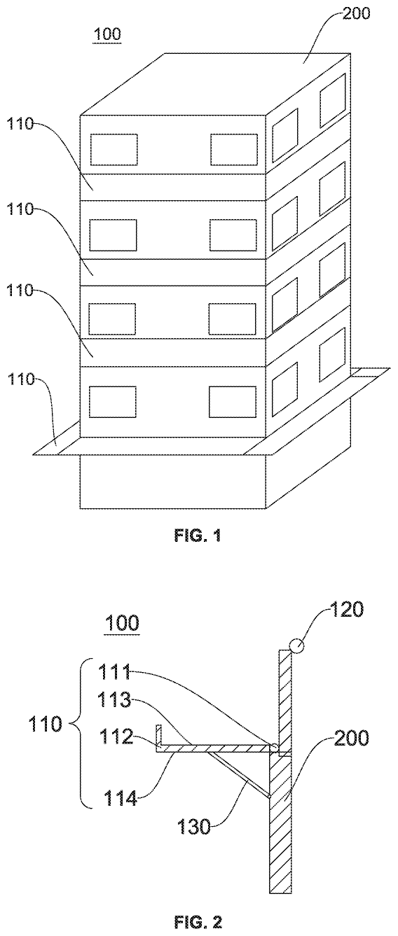

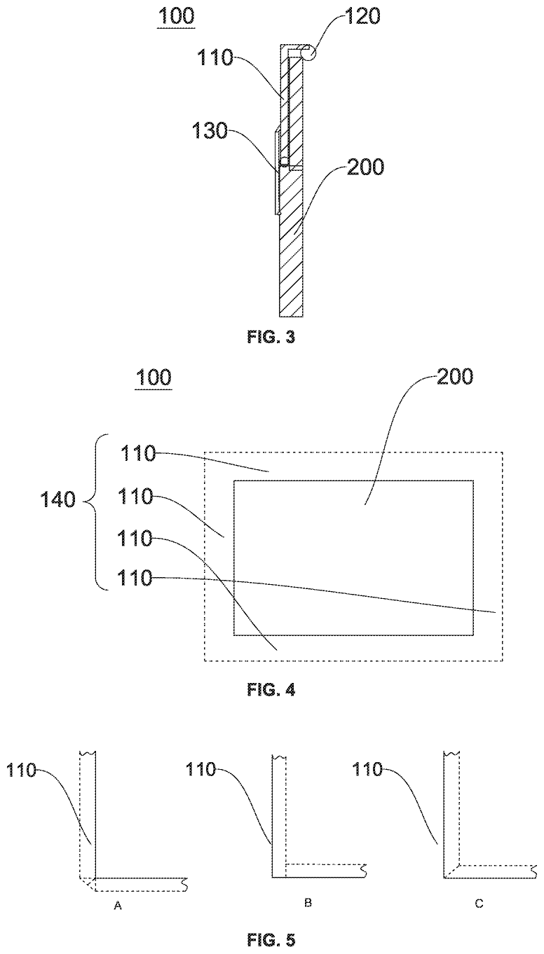

With reference to FIG. 1, FIG. 2, and FIG. 3, this embodiment provides an escape system 100, which comprises escape panels 110 disposed around an exterior wall 200 of a building and disposed on some or all of the floors, locking parts 120, and support components 130.

The escape panel 110 has an operative (open) state and an inoperative (closed) state, and the support component 130 has a first support state and a second support state. The escape panel 110 is disposed at a window of the exterior wall 200 of the building. When the escape panel 110 is in the operative state, it may have a width of 0.8 meters or 1.2 meters or more, which not only facilitates the design of vertical window, but also meets the latest standard for fire protection design in high-rise buildings.

In the above, the multiple escape panels 110 on the same floor may be simultaneously maintained in the operative state or the inoperative state, or may be partially maintained in the operative state or the inoperative state. Further, referring to FIG. 4 and FIG. 5 (dashed lines in the figures represent the escape panels 110). When the multiple escape panels 110 on the same floor are simultaneously in the operative state, they may surround the exterior wall 200 of the building to form an annular closed passage 140 connected to the exterior wall 200 of the building. The closed passage 140 is interconnected around the building. To allow the multiple escape panels 110 on the same floor to be connected to form an annular closed passage 140, an additional support plate may be added at a gap as shown in A of FIG. 5, or a region may be removed at inner corners of one escape panel 110 as shown in B of FIG. 5, or two escape panels 110 may be formed in a complementary form as shown in C of FIG. 5. All these designs facilitate the formation of a continuous escape passage by escape panels 110 located on adjacent wall surfaces at the corner of the wall, which also advantageously allows an escaping person to smoothly pass through the corner of the wall via the escape panels 110.

Still further, the escape panel 110 has the functions of load bearing and preventing fire and insulating heat. As an implementation, with continued reference to FIG. 2, when the exterior wall 200 of the building is made of a glass material, the escape panel 110 may comprise a load-bearing layer 113 and a fireproof and heat-insulating layer 114. A portion between the load-bearing layer 113 and the fireproof and heat-insulating layer 114 is hollow to insulate heat, wherein the fireproof and heat-insulating layer 114 may be made of aerogel or some materials capable of transmitting light and having the fireproofing and heat-insulating function, and the load-bearing layer 113 may be made of heat-insulating tempered glass. Further, the fireproof and heat-insulating layer 114 is located on a first surface of the escape panel 110, and the load-bearing layer 113 is located on a second surface of the escape panel 110, wherein the second surface refers to a surface in direct contact with the escaping person after the escape panel 110 is horizontally unfolded, and the first surface is a surface opposite to the second surface. For example, in the state depicted in FIG. 2, the fireproof and heat-insulating layer 114 is located on the lower surface (i.e., the first surface) of the escape panel 110, and the load-bearing layer 113 is located on the upper surface (i.e., the second surface) of the escape panel 110. The surface of the exterior wall of the building is an important path along which flames run upward. The escape panel 110 which is unfolded horizontally is equivalent to an obstacle disposed in the path, which can isolate the upward running flames to a certain extent. On the other hand, if there is a flame below the escape panel 110 (for example, the flame runs out from a window on the lower floor), the escape panel 110 provided with a fireproof and heat-insulating layer on its lower surface heats up slowly, which can further reduce the difficulty of escape.

A hollow structure may be used between the load-bearing layer 113 and the fireproof and heat-insulating layer 114 to serve the heat insulating function, and the hollow structure may have a pressure balancing hole communicating with the outside. In other embodiments, a flame-retardant and heat-insulating material, such as heat-insulating cotton or aerogel or the like, may be filled between the load-bearing layer 113 and the fireproof and heat-insulating layer 114 to form a non-hollow structure. Alternatively, a hollow structure may be used in combination with filling a heat-insulating material between the load-bearing layer 113 and the fireproof and heat-insulating layer 114.

Further, glass windows or glass curtain walls provided on the building may also be designed for reinforcing the escape panels 110, which are rotatably connected by means of the locking parts 120 and the support components 130 to form closed escape passages. As another implementation, when the exterior wall 200 of the building is made of a non-glass material, the escape panel 110 may be made of a composite material into which load-bearing, heat insulation, fire prevention, and heat preservation functions are integrated, and walls inside the escape panels 110 no longer need to undergo heat preservation treatment, and a transverse heat-preservation layer partition is naturally formed, which is very important for protection of the building from fire. When the escape panel 110 is in the operative state, the fireproof and heat-insulating layer 114 faces the ground for isolating flames and preventing upward spreading of the flames. A surface of the fireproof and heat-insulating layer 114 facing the ground may be made in the same color as the exterior wall 200 of the building. When the escape panels 110 are in the inoperative state, they are integrated with the entire building without affecting the appearance of the building.

As an implementation, the escape panel 110 may be one entire panel. As another implementation, the escape panel 110 may be a movable panel that is foldable or rollable.

With continued reference to FIG. 2, the escape panel 110 includes a first end 111 and a second end 112. The first end 111 may be rotatably connected to the exterior wall 200 of the building by a screw with damping property, and the second end 112 is detachably connected to the exterior wall 200 of the building by means of the locking part 120, wherein the second end 112 may be in an “L” shape as shown in FIG. 2, or may be in a linear shape. The locking part 120 may be disposed at a window sill of the resident (similarly to a locking member for a window), and may serve the function of restricting the escape panel 110 so that the escape panel 110 is prevented from being unfolded and is kept flush with the exterior wall 200 of the building. When the resident finds that a fire has occurred, the resident may release the restriction of the escape panel 110 by the locking part 120, so that the escape panel 110 is in the operative state. It is worth noting that the locking part 120 corresponding to a certain escape panel 110 may allow some or all of the escape panels 110, which are located on the same floor and connected to one another, to be in the operative state simultaneously.

Further, an elastic member may be designed at the locking part 120 so that the escape panel 110 can be opened conveniently and quickly with the use of inertia. Still further, the escape system 100 may further comprise a winch (or a hoist), and the winch is disposed on the roof of the building. The winch is connected to the escape panels 110 on each floor and is used for retracting the unfolded escape panels 110 on all the floors so that the escape panels 110 are in the inoperative state again and kept flush with the exterior wall 200 of the building when a fire warning or hidden trouble is eliminated. In other embodiments, the winch may also be configured to be in a free-release operating state when a fire warning is issued. In this operating state, all the escape panels 110 may be freely released, so that the escape panels 110 on each floor are rapidly in the operative state. Of course, a retracting component may also be provided for the escape panels 110 on each floor. In this case, the retracting component needs to be connected to the escape panels 110 on each floor, so as to achieve the linkage of the escape panels 110 on each floor.

The support component 130 has one end connected to the escape panel 110, and the other end rotatably connected to the exterior wall 200 of the building.

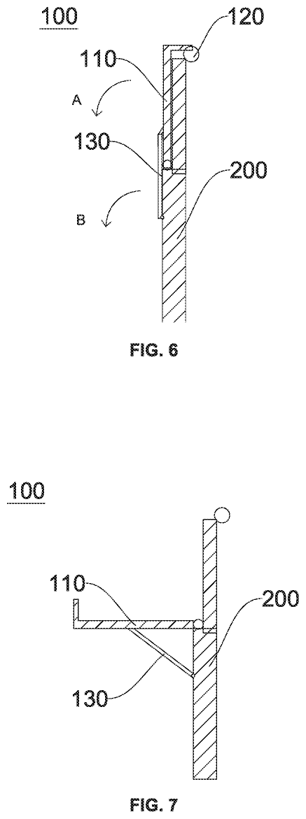

Referring to FIG. 6 and FIG. 7, the support component 130 may support from the bottom of the escape panel 110 by using an extendable structure, such as a multi-section sleeve structure or the like. The support component 130 is in a stretched state when being in the first support state, and the support component 130 is in a contracted state when being in the second support state. When being in the second support state, the support component 130 may be in a contracted limit state, or a locking structure may be provided so that the support component 130 is kept at a preset length.

When the escape panel 110 is in the inoperative state of FIG. 6, the escape panel 110 drives the support component 130 to be flush with the exterior wall 200 of the building. When the escape panel 110 is changed from the inoperative state to the operative state of FIG. 7 in a direction indicated by an arrow A shown in FIG. 6, the second end 112 is separated from the exterior wall 200 of the building, so that the entire escape panel 110 is perpendicular to the exterior wall 200 of the building, and drives the support component 130 to change from the first support state to the second support state. It is worth noting that the perpendicularity here does not necessarily mean absolute perpendicularity. When the escape panel 110 is in the operative state, the escape panel may form an angle of 90°±10° relative to the exterior wall 200 of the building and may be substantially horizontal.

Further, one end of the support component 130 is movably connected to the escape panel 110. For example, a sliding slot is provided in the surface of the escape panel 110, an end portion of the support component 130 is slidably embedded in the sliding slot, and the end portion of the support component 130 may be slidable relative to the escape panel 110 when the escape panel 110 is switched between the operative state and the inoperative state. Further, in order to achieve a better supporting effect, in an optional embodiment, a stop wall may be provided in the sliding slot to restrict continued outward sliding of the support component 130. When the escape panel 110 is in a horizontal state, the end portion of the support component 130 abuts exactly against the stop wall. In another optional embodiment, an angle restricting structure may be provided, the angle restricting structure is used for restricting a maximum angle at which the support component 130 is unfolded, and the end portion of the support component 130 can abut exactly against the bottom surface of the escape panel 110 which is in the horizontal state when it is unfolded at the maximum angle. Of course, only one or both of the stop wall and the angle restricting structure may be provided.

As an implementation, the end of the support component 130 connected to the escape panel 110 may be connected to a lower end surface of the escape panel 110. When the escape panel 110 is in the operative state, the support component 130 changes in a direction indicated by an arrow B shown in FIG. 6 to the second support state of FIG. 7 along with the escape panel 110 to form a triangular support perpendicular to the building, so as to serve the function of supporting the escape panel 110. One escape panel 110 may be connected to only one support component 130. In this case, the support component 130 and the escape panel 110 may be connected at the middle position of the escape panel 110. Of course, one escape panel 110 also may be connected to two or more support components 130 simultaneously to increase the safety of the escape panel 110.

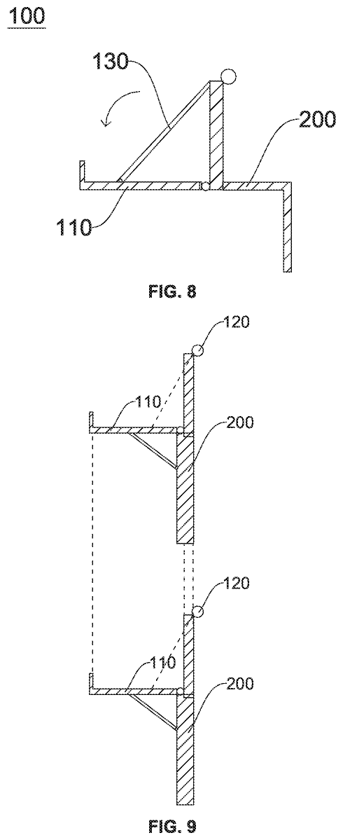

Sometimes the exterior wall of a building is provided with an external platform for an outdoor air conditioner or with an external balcony, which will affect the switching of the state of the support component 130. Therefore, as another implementation, referring to FIG. 8, the support component 130 may be connected to an upper end surface of the escape panel 110. When the support component 130 is connected to the upper end surface of the escape panel 110, the support component 130 may be a steel rope for serving the function of pulling the escape panel 110, which may avoid the occupation of the position of the support component 130 by the external platform for an outdoor air conditioner or by the external balcony. When the escape panel 110 is pulled by the steel rope, an inclined angle is formed between the steel rope and the escape panel 110, which might cause a safety hazard to the escaping person. Therefore, in order to avoid this problem, the surface of the steel rope may be coated with a reflective material or a noctilucent material, so as to remind the escaping person to escape across the steel rope to avoid falling down.

It is worth noting that the escape panel 110 may be flush with an interior floor of the building or may be higher or lower than the interior floor when the escape panel is in the operative state. Further, a handle having an end portion provided with a sharp corner may be disposed at the window sill of the resident. When the escaping person wants to bring the escape panel 110 into the operative state by releasing the locking part 120, the handle can be taken out to hit the window. Still further, the escape system 100 further comprises an alarm apparatus, which is connected to the locking part 120. When the escape panel 110 is in the operative state, the alarm apparatus may be triggered for alarming, wherein the alarm apparatus may be a speaker.

The locking part 120 may control the states of multiple escape panels 110 only on the floor where it is located. As an implementation, referring to FIG. 9, the locking parts 120 located on the upper and lower adjacent floors may be connected to the escape panel 110 on the lower floor via a connecting rod or a connecting wire. When the escape panel 110 located on the M-th floor is opened, the escape panel 110 on the (M+1)-th floor may also be pulled into the operative state due to the action of the connecting rod. Since the lower end surface of the escape panel 110 is made of the fireproof and heat-insulating layer 114, an effect of isolating the fire can be achieved to prevent the fire from spreading to the upper-level structure through the heat preservation material to cause greater hazard, thereby suppressing the fire from burning to the upper floors. Further, when the locking parts 120 on the upper and lower adjacent floors are connected to the escape panels 110 on the lower floors via connecting rods, the connecting rods may form an escape passage in the vertical direction, and an escaping person may get a chance to escape with the use of the connecting rods.

As an implementation, the escape system 100 may further be provided with a sprinkler apparatus for being connected to a fire pipe network, which is used for mitigating lateral expansion of the fire on the floor where it is located.

As an implementation, the escape system 100 may further be provided with a lighting device for emergency lighting at night. Moreover, the escape system may be opened or closed in a fire protection room of the building. Still further, when a smoke sensing apparatus gives an alarm, the escape panels 110 on a floor where the smoke sensing alarm is sounded and on an upper floor are automatically opened, whereby intelligent control can be achieved.

As an implementation, the escape system 100 may further be provided with a surveillance camera system, wherein the escape panels and passages from the escape panels to the interior of the building are all within the range of vision of the surveillance camera. Moreover, users may watch video information acquired by the surveillance camera system using mobile devices such as mobile phones. Rescue information and the security statuses of residents can be known by using such a surveillance camera system. For example, it can be known whether a thief enters the building through the escape panels. A storage device may be provided separately to store and back up the video information, or the surveillance camera system may be connected to a security protection system of the building and store and back up the information with the use of a storage device of the security protection system.

The escape system 100 according to the first embodiment of the present disclosure comprises escape panels 110 disposed around an exterior wall 200 of a building and disposed on some or all of the floors, locking parts 120, and support components 130. In the event of a fire, escaping persons can disengage the locking part 120 at each window so that the escape panels 110 on that floor form an escape passage surrounding the exterior wall 200 of the building. Then the escaping persons can move on the escape panels 110 to temporarily go to a unit where no fire has occurred to take shelter and await rescue by firefighters. If there is no fire in the vicinity of a fire escape of the building, the escaping persons may also go to the fire escape over the escape panels 110 and quickly escape through the fire escape. Alternatively, a fire elevator is disposed at a suitable location of the building. The escaping persons on each floor may enter the fire elevator from the escape panels 110 and quickly descend to the ground by using the fire elevator. The firefighters can also achieve rapid rescue by means of the escape panels 110.

### Second Embodiment

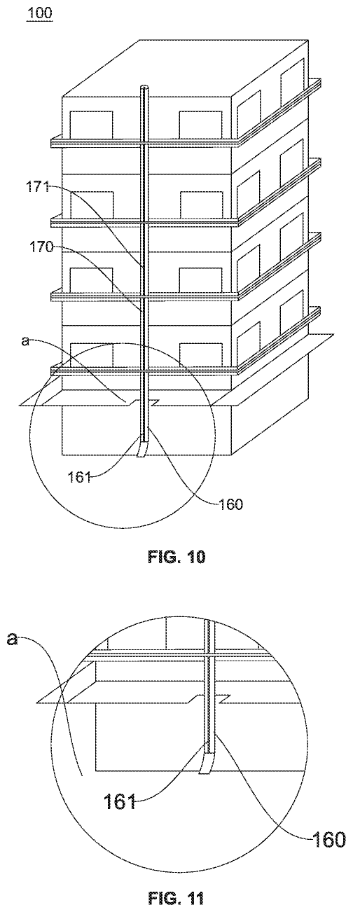

Referring to FIG. 10 and FIG. 11, this embodiment provides an escape system 100, which comprises escape panels 110 disposed around an exterior wall 200 of a building and disposed on some or all of the floors, locking parts 120, and support components 130. This embodiment is different from the first embodiment mainly in that the escape system 100 may further comprise transverse pipelines 160 and a longitudinal pipeline 170. At least one of a fire pipe network and a sprinkler apparatus, a fire extinguishing apparatus, a night emergency lighting apparatus, and a camera apparatus may be provided on the transverse pipelines and the longitudinal pipeline.

The longitudinal pipeline 170 extends from the top floor to the bottom floor of the building, and is fixed to a wall of the building that is not adjacent to windows. Of course, some buildings have a front surface entirely made of glass. In this case, the longitudinal pipeline 170 may be disposed on any safe wall of the building. As an implementation, a notch for allowing an escaping person to descend therethrough is needed to be reserved for the longitudinal pipeline 170 in the escape panel 110 on each floor. The transverse pipelines 160 are disposed at window sills of the exterior wall 200 of the building, and the transverse pipelines 160 communicate with the longitudinal pipeline 170. Of course, the longitudinal pipeline 170 is not necessarily disposed only at the position shown in FIG. 10, or may be disposed at any position of the building. Further, there may be multiple longitudinal pipelines 170 in the same building. Of course, the longitudinal pipeline 170 may also be disposed on a side of the exterior wall 200 of the building that is recessed and that has no window, and is preferably located on a windward side of the building.

The transverse pipeline 160 is provided with a transverse sliding slot 161 extending from one port to the other port, and the longitudinal pipeline 170 is provided with a longitudinal sliding slot 171 extending from one port to the other port (from the roof to the ground). Each home may be equipped with a slow-descent escape device, which may comprise a friction block and a rope or wearable device connected to the friction block. The friction block is to be disposed in the transverse sliding slot 161 and has a larger size than the transverse sliding slot 161. The friction block may act only on the inner wall of the longitudinal pipeline to generate a frictional force, or act only on the outer wall of the longitudinal pipeline to generate a frictional force, or may act on both the inner wall and the outer wall of the longitudinal pipeline to generate a frictional force. In the event of a fire, the escaping person may tie the rope or wear the wearable device in the house, and then open the escape panel 110 and move onto the escape panel 110 by opening a window or breaking glass.

Being pulled by the slow-descent escape device, the escaping person can move on the escape panel 110 at full speed. When the escaping person moves to the longitudinal pipeline 170, the friction block slides from the transverse sliding slot 161 into the longitudinal sliding slot 171, and the escaping person descends from the higher floor to the bottom floor at a slow and constant speed by the sliding of the friction block in the longitudinal sliding slot 171. Of course, the escaping persons may also escape through another unit where no fire has occurred.

As an implementation, a region of the transverse pipeline 160 close to the window is provided with an opening facing the roof, and the opening communicates with the transverse sliding slot 161, so that an escaping person can conveniently insert or remove the friction block into or from the transverse sliding slot 161 at any window, so as to select the best escape route. The opening has a size larger than the friction block.

As an implementation, the longitudinal sliding slot 171 may have an inner diameter dimension smaller than the inner diameter dimension of the transverse sliding slot 161 and slightly larger than the size of the friction block, so that a frictional force between the friction block and the longitudinal sliding slot 171 is increased while the escaping person is sliding down through the longitudinal sliding slot 171, such that the escaping person can descend at a constant speed. When escaping persons are allowed to descend slowly at a constant speed, escaping persons with different weights may be allowed to descend at a constant speed and may descend at a constant speed of 1 to 3 m/s, such that collisions of multiple escaping persons are prevented. It is worth noting that the longitudinal pipeline 170 should also be provided with an anti-collision apparatus and an emergency stopping apparatus. In addition, a cooling apparatus and an antistatic apparatus should be mounted to the transverse pipelines 160 and the longitudinal pipeline 170.

As an implementation, an end of the longitudinal pipeline 170 close to the ground may be connected with a soft slope connected to the ground. An escaping person who descends to the position of the slope may slide down to the ground safely.

As an implementation, the longitudinal pipeline 170 is not limited to a straight pipeline shown in FIG. 10, or may be a pipeline in a curved shape, for example, an “S”-shaped pipeline or any other irregularly-shaped curved pipeline.

As an implementation, the escape system 100 according to the second embodiment may further be provided with a lighting device for emergency lighting at night, and the escape system 100 may be opened or closed in a fire protection room of the building.

The escape system 100 according to the second embodiment of the present disclosure comprises escape panels 110 disposed around an exterior wall 200 of a building and disposed on some or all of the floors, locking parts 120, support components 130, transverse pipelines 160, and a longitudinal pipeline 170. In the event of a fire, escaping persons can disengage the locking part 120 at each window so that the escape panels 110 on that floor form an escape passage surrounding the exterior wall 200 of the building. Then the escaping persons can move on the escape panels 110 to temporarily go to a room or unit where no fire has occurred to take shelter and await rescue by firefighters. If there is no fire in the vicinity of a fire escape of the building, the escaping persons may also go to the fire escape over the escape panels 110 and quickly escape through the fire escape. In addition, the escaping person may also wear a slow-descent escape device placed in the house, move quickly to the longitudinal pipeline 170 by sliding of a friction block in the transverse sliding slot 161 of the transverse pipeline 160, and descend to the ground at a constant speed by a movement of the friction block in the longitudinal sliding slot 171 of the longitudinal pipeline 170 and by an action of the friction block on an inner wall or an outer wall or both the inner and outer walls of the longitudinal pipeline. The friction block and the wearable device may also be connected by a rigid connecting rod. In this way, a certain safety distance can be maintained between the escaping person and the longitudinal pipeline.

### Third Embodiment

The escape panels 110 of the escape system according to this embodiment are all movably connected to the exterior wall of the building. In the embodiments described above, the movable connection is specifically rotatable connection. In this embodiment, the first end of the escape panel is slidably connected to the exterior wall of the building.

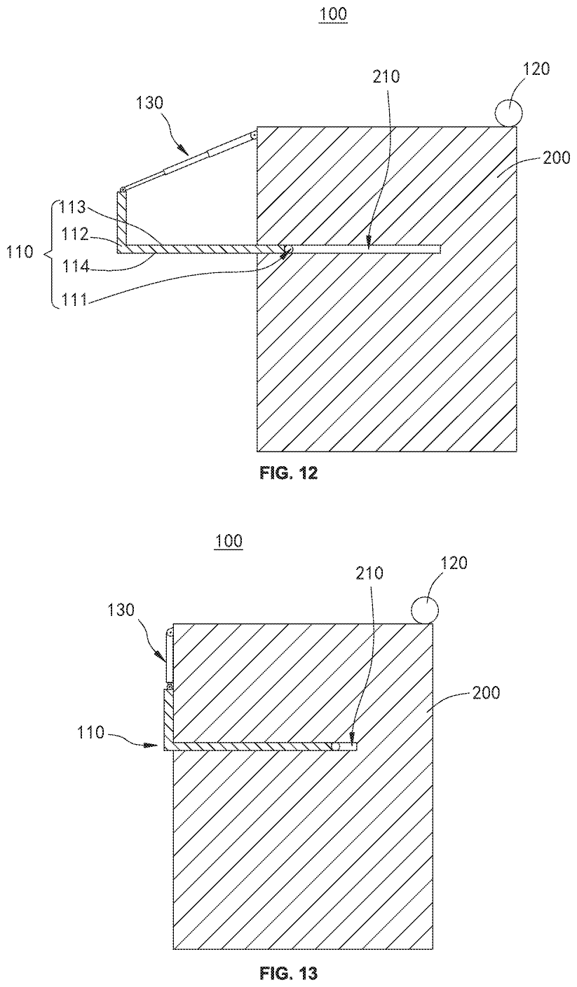

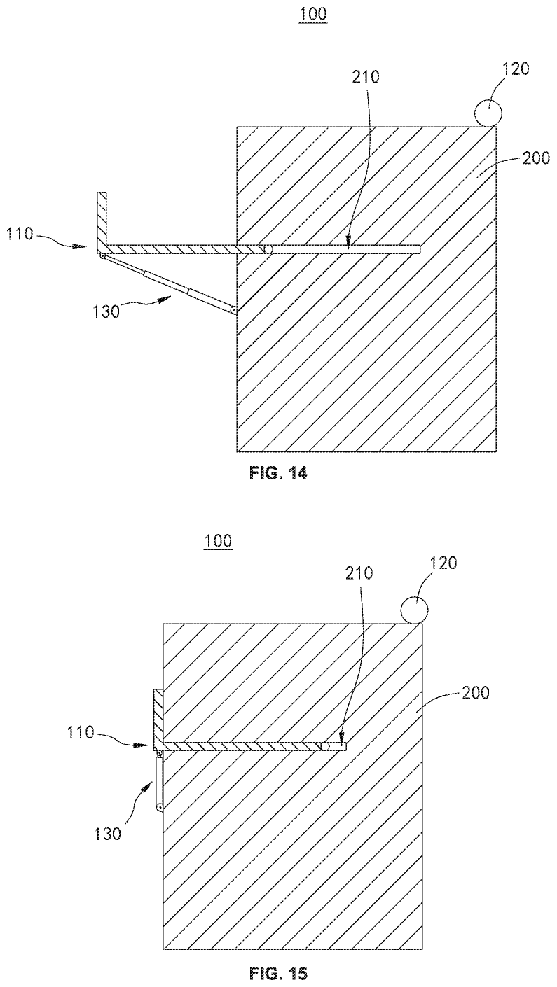

Further, as shown in FIG. 12 and FIG. 13, a groove 210 is provided in the exterior wall 200 of the building, and the groove 210 has an opening extending through the wall surface. The escape panel 110 is disposed in the groove 210 and may be slidably connected to the groove 210 by means of a sliding slot or the like to form a drawer-like structure with the exterior wall 200 of the building.

The locking part 120 has an operative state and an inoperative state, the escape panel 110 also has an operative state and an inoperative state, and the support component 130 has a first support state and a second support state. The escape panel 110 may be disposed at a window of the exterior wall 200 of the building. Of course, when the exterior wall 200 of the building is made of a structure with doors, windows, and walls, the escape panel 110 may be disposed below or in a floor slab, and the floor slab can serve the function of stabilizing and bearing the escape panel 110. The structure and arrangement of the support component 130 may be understood with reference to any of the above embodiments.

When the locking part 120 is in the operative state, the escape panel 110 is hidden in the groove 210, the support component 130 is in the first support state, and the escape panel 110 is kept flush with the exterior wall 200 of the building. When the locking part 120 is in the inoperative state, the escape panel 110 is extended outward from the groove 210 to a preset size, and the support component 130 is in the second support state and serves to support the escape panel 110. At this time, the escape panel 110 is perpendicular to the exterior wall 200 of the building, and all the escape panels 110 in the stretched state surround the exterior wall 200 of the building to form a closed passage.

In order to enable the escape panel 110 to be extended out of the wall faster, an elastic part (not shown in the figure), such as a spring, may be disposed in the groove 210. The elastic part can abut against the escape panel 110 and the inner wall of the groove 210. When the escape panel 110 is hidden inside the groove 210, the elastic part is in a compressed state. When unlocked by the locking part 120, the escape panel 110 can be rapidly ejected under the action of the elastic part.

Further, the escape system further comprises a positioning mechanism which is configured to lock the escape panel 110 in an extended state to avoid a movement of the escape panel 110 during use. The locking of the escape panel 110 by the positioning mechanism is releasable, and the locking by the positioning mechanism can be released to hide the escape panel 110 in the groove 210. Further, the positioning mechanism may comprise an elastic boss and a positioning slot. For example, an elastic boss extending through the lower surface of the escape panel 110 is mounted to the escape panel 110, and at the same time, a pull ring connected to the elastic boss is mounted on the upper surface of the escape panel 110. The groove 210 is provided with a corresponding positioning slot. When the escape panel is extended outward to the preset size, the position of the elastic boss is exactly opposite to the positioning slot, and the elastic boss moves downward under the action of its own elastic force and extends into the positioning slot to achieve positioning. When it is necessary to hide the escape panel 110 in the groove 210, the locking by the positioning mechanism can be released by pulling the pull ring upward. In some embodiments, the unlocking can also be achieved by an electronically controlled power device. In this way, the efficiency of resetting of the escape system can be improved.

In the above, such a groove 210 can generally be provided only in an area between load-bearing walls, and cannot be provided at the load-bearing wall. When multiple escape panels 110 on the same floor are connected to form an annular closed passage 140, there may be a gap in the annular closed passage 140 due to the presence of a load-bearing wall between two parallel rooms. In order to solve this problem, preferably, the edge of the escape panel 110 may be provided with a foldable extension plate, which is used for connecting a void caused by the presence of a load-bearing wall. Preferably, as shown in FIGS. 5A to 5C, two escape panels 110 may be formed in a complementary form. In FIG. 5A and FIG. 5C, the void area is filled with two extension plates, and in FIG. 5B, the void area is filled with one extension plate.

Further, as shown in FIG. 14 and FIG. 15, in some of the embodiments of the present disclosure, the support component 130 may support from the bottom of the escape panel 110 by using an extendable structure, such as a multi-section sleeve structure or the like. The support component 130 is in a contracted state when being in the first support state (the escape panel 110 is retracted), and the support component 130 is in a stretched state when being in the second support state (the escape panel is extended out). The support component 130 may be provided with a locking structure so that the support component 130 is maintained at a preset length when being in the second support state. Of course, the support component may also be unlocked to change back to the first support state from the second support state. Further, the support component 130 may be connected to the outer edge of the escape panel 110, in order to allow the escape panel 110 to be hidden in the groove 210 as much as possible. Further, because the preset maximum extendable length of the support component 130 can restrict the extended length of the escape panel 110, the positioning mechanism described above may also be replaced by the support component 130.

In summary, the present disclosure provides a safety escape system 100, comprising escape panels 110 disposed around an exterior wall 200 of a building and disposed on some or all of the floors, locking parts 120, and support components 130, wherein the escape panels 110 are arranged to surround the exterior wall 200 of the building to form closed passages 140, the escape panels 110 have first ends 111 rotatably connected to the exterior wall 200 of the building, and second ends 112 detachably connected to the exterior wall 200 of the building by means of the locking parts 120, and the support components 130 each have one end connected to the escape panel 110, and the other end rotatably connected or slidably connected to the exterior wall 200 of the building. In the event of a fire, escaping persons can disengage the locking part 120 at each window so that the escape panels 110 on that floor form an escape passage surrounding the exterior wall 200 of the building. Then the escaping persons can move on the escape panels 110 to temporarily go to a unit where no fire has occurred to take shelter and await rescue by firefighters. If there is no fire in the vicinity of a fire escape of the building, the escaping persons may also go to the fire escape over the escape panels 110 and quickly escape through the fire escape. The escaping person may also wear a slow-descent escape device with a friction block placed in the house, move quickly to the longitudinal pipeline 170 by sliding of the friction block in the transverse sliding slot 161 of the transverse pipeline 160, and descend to the bottom floor at a constant speed by a movement of the friction block in the longitudinal sliding slot 171 of the longitudinal pipeline 170.

The above description is merely illustrative of preferred embodiments of the present disclosure and is not intended to limit the present disclosure. It will be understood by those skilled in the art that various modifications and variations can be made to the present disclosure. Any modifications, equivalent alternatives, improvements and so on made within the spirit and principle of the present disclosure are to be included in the scope of protection of the present disclosure.

### INDUSTRIAL APPLICABILITY

The escape system according to an embodiment of the present disclosure can surround an exterior wall of a building to form closed passages. In the event of a fire, escaping persons can disengage the locking part at each window so that the escape panels on that floor form an escape passage surrounding the exterior wall of the building. Then the escaping persons can move on the escape panels to temporarily go to a unit where no fire has occurred to take shelter and await rescue by firefighters. If there is no fire in the vicinity of a fire escape in another unit of the building, the escaping persons may also go to the fire escape in another unit over the escape panels and quickly escape through the fire escape. In the event of a major fire or failure to escape through the fire escape in another unit, the escaping persons may descend to the ground at a constant speed by means of the connection of escape connecting rods disposed transversely below window sills of the exterior wall to escape connecting rods disposed longitudinally and attached to the wall. Unobstructed horizontal annular escape passages and rescue passages are formed by opening the escape panels on that floor and the upper floor, and spreading of the fire to the upper floors through heat preservation layers or windows can be suppressed as much as possible.

1. An escape system, comprising escape panels, which are disposed around an exterior wall of a building and disposed on some or all of floors, locking parts, and support components, wherein the escape panels are arranged to surround the exterior wall of the building to form closed passages, each of the escape panels has a first end rotatably connected to the exterior wall of the building, and a second end detachably connected to the exterior wall of the building by means of one of the locking parts, each of the support components has one end connected to one of the escape panels, and the other end rotatably connected to the exterior wall of the building, each of the escape panels can be in an operative state and an inoperative state, each of the support components can be in a first support state and a second support state, wherein when being in the inoperative state, one of the escape panels drives one of the support components to be flush with the exterior wall of the building, and when one of the escape panels is in the operative state, the second end is separated from the exterior wall of the building so that the one escape panel is perpendicular to the exterior wall of the building and drives one of the support components to change from the first support state to the second support state.

2. The escape system according to claim 1, wherein each of the support components has one end connected to an upper end surface or a lower end surface of one of the escape panels, and the other end rotatably connected to the exterior wall of the building.

3. The escape system according to claim 1, wherein one of the escape panels is higher than an interior floor of the building, or lower than the interior floor of the building, or flush with the interior floor of the building when the one escape panel is in the operative state.

4. The escape system according to claim 1, wherein multiple escape panels located on a same floor are simultaneously maintained in the operative state or the inoperative state, or the multiple escape panels located on the same floor are partially maintained in the operative state or the inoperative state.

5. The escape system according to claim 1, wherein the locking parts located on upper and lower floors are connected to the escape panels on a lower floor via connecting rods or connecting wires.

6. The escape system according to claim 5, wherein the connecting rods on outer sides of the escape panels on each floor are connected to form an escape passage in a vertical direction.

7. The escape system according to claim 1, wherein the locking parts or the support components are provided with elastic members for quickly opening the escape panels.

8. The escape system according to claim 1, wherein the escape system further comprises a winch, wherein the winch is connected to the escape panels on each floor, or the escape system further comprises multiple retracting components, wherein the retracting components are connected to the escape panels on a same floor therewith.

9. The escape system according to claim 1, wherein the escape system further comprises transverse pipelines and a longitudinal pipeline, each of the transverse pipelines is provided with a transverse sliding slot extending from one port to another port, the longitudinal pipeline is provided with a longitudinal sliding slot extending from one port to the other port, each of the transverse pipelines is disposed at a window sill of the exterior wall of the building, a region of each of the transverse pipelines close to a window is provided with an opening facing a roof, the opening communicates with the transverse sliding slot, the opening is used for receiving a slow-descent escape device with a friction block, the opening has a larger size than the friction block, the longitudinal pipeline is fixed on a wall or located on outer sides of the escape panels and leads to a ground, and the transverse pipelines communicate with the longitudinal pipeline, the longitudinal sliding slot communicates with the horizontal sliding slot on each floor, the longitudinal sliding slot has a smaller size than the friction block, and the friction block acts on one or both of an inner wall of the longitudinal sliding slot of the longitudinal pipeline and an outer wall of the longitudinal pipeline to generate a frictional force.

10. The escape system according to claim 9, wherein the longitudinal sliding slot has an inner diameter smaller than the transverse sliding slot in dimension.

11. The escape system according to claim 9, wherein an end of the longitudinal pipeline close to the ground or the roof is connected with a soft slope connected to the ground or the roof.

12. The escape system according to claim 9, wherein the longitudinal pipeline is a vertical pipeline or a curved pipeline.

13. The escape system according to claim 9, wherein the transverse pipelines and the longitudinal pipeline are provided with a fire pipe network and a sprinkler apparatus, a fire extinguishing apparatus, a night emergency lighting apparatus, and a camera apparatus.

14. The escape system according to claim 9, wherein the escape system further comprises glass windows or glass curtain walls, wherein the glass windows or the glass curtain walls are designed for reinforcing the escape panels, which are rotatably connected by means of the locking parts and the support components to form closed escape passages.

15. The escape system according to claim 1, wherein the escape panels are controlled to be opened or closed by a fire protection room of the building so as to achieve an intelligent control.

16. The escape system according to claim 1, wherein the escape panels are foldable or rollable.

17. The escape system according to claim 1, wherein each of the escape panels comprises a load-bearing layer and a fireproof and heat-insulating layer, and the fireproof and heat-insulating layer faces the ground when one of the escape panels is in the operative state.

18. The escape system according to claim 1, wherein the escape system further comprises an alarm apparatus which is connected to the locking parts.

19. An escape system, comprising escape panels, which are disposed around an exterior wall of a building and disposed on some or all of floors, locking parts, and support components, wherein the escape panels are arranged to surround the exterior wall of the building to form closed passages, each of the escape panels has a first end movably connected to the exterior wall of the building, and a second end detachably connected to the exterior wall of the building by means of one of the locking parts, each of the support components has two ends connected to one of the escape panels and to the exterior wall of the building, respectively, each of the escape panels can be in an operative state and an inoperative state, each of the support components can be in a first support state and a second support state, wherein when being in the inoperative state, one of the escape panels drives one of the support components to be flush with the exterior wall of the building, and when one of the escape panels is in the operative state, the second end is separated from the exterior wall of the building so that the one escape panel is perpendicular to the exterior wall of the building and drives one of the support components to change from the first support state to the second support state.

20. An escape system, comprising escape panels, which are disposed around an exterior wall of a building and disposed on some or all of floors, locking parts, and support components, wherein grooves are provided in the exterior wall of the building, each of the escape panels has a first end disposed in one of the grooves and slidably connected to the one groove, and a second end connected to the exterior wall of the building by means of one of the support components; each of the locking parts is disposed on the building and connected to one of the escape panels, each of the locking parts can be in an operative state and an inoperative state, each of the escape panels can be in a contracted state and a stretched state, each of the support components can be in a first support state and a second support state, wherein when one of the locking parts is in the operative state, one of the escape panels is in the contracted state, the one escape panel drives one of the support components into the first support state, and the second end of the one escape panel is flush with the exterior wall of the building; when one of the locking parts is in the inoperative state, one of the escape panels is ejected horizontally from one of the grooves relative to the exterior wall of the building to be in the stretched state, the one escape panel drives one of the support components into the second support state, and the second end of the one escape panel is far away from the exterior wall of the building, so that the one escape panel is in a horizontal state relative to a ground, and all the escape panels in the stretched state surround the exterior wall of the building to form closed passage.
